(19) United States
(12) Patent Application Publication
(10) Pub. No.: US 2026/0281787 A1
(43) Pub. Date: Sep. 17, 2026

(54) DATA TRANSMISSION METHOD

(71) Applicant: Tencent Technology (Shenzhen) Company Limited, Shenzhen (CN)

(72) Inventor: Zhuoyun ZHANG, Shenzhen (CN)

(73) Assignee: Tencent Technology (Shenzhen) Company Limited, Shenzhen, GD (CN)

(21) Appl. No.: 19/668,570

(22) Filed: May 5, 2026

Related U.S. Application Data
(63) Continuation of application No. PCT/CN2024/104475, filed on Jul. 9, 2024.

(30) Foreign Application Priority Data
Dec. 7, 2023 (CN) 202311684001.8

(51) Int. Cl. H04W 28/02; H04W 40/02

(52) U.S. Cl. CPC H04W 28/0215; H04W 40/02

(57) ABSTRACT

In a data transmission method, user equipment (UE) route selection policy rule information that includes a traffic descriptor and a backend UE descriptor included in the traffic descriptor or the UE route selection policy rule information independent of the traffic descriptor is received. The backend UE descriptor includes traffic description information and a route selection information, and the traffic description information indicates one or more of a backend device type, a domain descriptor, an Internet protocol descriptor, or connection capability information. In the method, whether the UE route selection policy rule information matches a backend UE connected to the terminal device is determined. In the method, when the UE route selection policy rule information matches the backend UE, communication between the backend UE and a mobile network through the terminal device is configured based on the backend UE descriptor.

### RELATED APPLICATIONS

The present application is a continuation of International Application No. PCT/CN2024/104475, filed on Jul. 9, 2024, which claims priority to Chinese Patent Application No. 202311684001.8, filed on Dec. 7, 2023, and entitled “DATA TRANSMISSION METHOD AND RELATED DEVICE.” The entire disclosures of the prior applications are hereby incorporated by reference.

### FIELD OF THE TECHNOLOGY

The disclosure relates to the field of communication technologies, including a data transmission method, a communication device, and a non-transitory computer-readable storage medium.

### BACKGROUND OF THE DISCLOSURE

A terminal (for example, a communication device such as user equipment or UE) may share a hotspot of the terminal, to enable one or more backend UEs to access a mobile network through the terminal. However, a backend UE accessing the network through a hotspot usually can only use a default quality of service (QoS) flow of a default protocol data unit (PDU) session of the terminal for data transmission, and therefore network quality of the backend UE cannot be ensured.

### SUMMARY

Embodiments of the present disclosure provide a data transmission method. In the method, user equipment (UE) route selection policy rule information that includes a traffic descriptor and a backend UE descriptor included in the traffic descriptor or the UE route selection policy rule information independent of the traffic descriptor is received by processing circuitry of a terminal device. The backend UE descriptor includes traffic description information and a route selection information, and the traffic description information indicates one or more of a backend device type, a domain descriptor, an Internet protocol descriptor, or connection capability information. In the method, whether the UE route selection policy rule information matches a backend UE connected to the terminal device is determined. In the method, when the UE route selection policy rule information matches the backend UE, communication between the backend UE and a mobile network through the terminal device is configured by the processing circuitry based on the backend UE descriptor.

Embodiments of the present disclosure provide a data transmission method. In the method, capability information of a terminal device is received by processing circuitry of a network processing device, the capability information indicating that the terminal device supports a function of configuring communication between a backend UE and a mobile network through the terminal device based on a backend UE descriptor. In the method, user equipment (UE) route selection policy rule information that includes a traffic descriptor and the backend UE descriptor included in the traffic descriptor or the UE route selection policy rule information independent of the traffic descriptor is generated by the processing circuitry. The backend UE descriptor includes traffic description information and a route selection information, and the traffic description information indicates one or more of a backend device type, a domain descriptor, an Internet protocol descriptor, or connection capability information. In the method, the UE route selection policy rule information is transmitted to the terminal device.

Embodiments of the present disclosure provide a terminal device that includes processing circuitry configured to receive user equipment (UE) route selection policy rule information that includes a traffic descriptor and a backend UE descriptor included in the traffic descriptor or the UE route selection policy rule information independent of the traffic descriptor, the backend UE descriptor including traffic description information and a route selection information, the traffic description information indicating one or more of a backend device type, a domain descriptor, an Internet protocol descriptor, or connection capability information. The processing circuitry is configured to determine whether the UE route selection policy rule information matches a backend UE connected to the terminal device. The processing circuitry is configured to, when the UE route selection policy rule information matches the backend UE, configure communication between the backend UE and a mobile network through the terminal device based on the backend UE descriptor.

Embodiments of the present disclosure provide a network processing device that includes processing circuitry configured to receive capability information of a terminal device, the capability information indicating that the terminal device supports a function of configuring communication between a backend UE and a mobile network through the terminal device based on a backend UE descriptor. The processing circuitry is configured to generate user equipment (UE) route selection policy rule information that includes a traffic descriptor and the backend UE descriptor included in the traffic descriptor or the UE route selection policy rule information independent of the traffic descriptor, the backend UE descriptor including traffic description information and a route selection information, the traffic description information indicating one or more of a backend device type, a domain descriptor, an Internet protocol descriptor, or connection capability information. The processing circuitry is configured to transmit the UE route selection policy rule information to the terminal device.

Embodiments of the present disclosure provide a non-transitory computer-readable storage medium storing instructions, which when executed by a processor, cause the processor to perform a data transmission method. In the method, user equipment (UE) route selection policy rule information that includes a traffic descriptor and a backend UE descriptor included in the traffic descriptor or the UE route selection policy rule information independent of the traffic descriptor is received. The backend UE descriptor includes traffic description information and a route selection information, and the traffic description information indicates one or more of a backend device type, a domain descriptor, an Internet protocol descriptor, or connection capability information. In the method, whether the UE route selection policy rule information matches a backend UE connected to the terminal device is determined. In the method, when the UE route selection policy rule information matches the backend UE, communication between the backend UE and a mobile network through the terminal device is configured based on the backend UE descriptor.

Embodiments of the present disclosure provide a non-transitory computer-readable storage medium storing instructions, which when executed by a processor, cause the processor to perform a data transmission method. In the method, capability information of a terminal device is received, the capability information indicating that the terminal device supports a function of configuring communication between a backend UE and a mobile network through the terminal device based on a backend UE descriptor. In the method, user equipment (UE) route selection policy rule information that includes a traffic descriptor and the backend UE descriptor included in the traffic descriptor or the UE route selection policy rule information independent of the traffic descriptor is generated. The backend UE descriptor includes traffic description information and a route selection information, and the traffic description information indicates one or more of a backend device type, a domain descriptor, an Internet protocol descriptor, or connection capability information. In the method, the UE route selection policy rule information is transmitted to the terminal device.

Embodiments of the present disclosure provide a data transmission method. The method is performed by a terminal (e.g., a terminal device), and the method includes: receiving a UE route selection policy rule (e.g., a communication device information), the UE route selection policy rule including backend UE route selection policy rules, each backend UE route selection policy rule including traffic description information and a route selection descriptor (e.g., route selection information), the traffic description information indicating traffic information of a backend UE, the backend UE accessing a mobile network through the terminal, and traffic of the backend UE that matches the traffic description information being based on route selection described in the route selection descriptor.

In some embodiments of the present disclosure, the method further includes: matching a target backend UE route selection policy rule from the backend UE route selection policy rules for the traffic of the backend UE when the backend UE accesses the mobile network through the terminal; and executing, when the target backend UE route selection policy rule is matched for the traffic of the backend UE, a target route selection descriptor in the target backend UE route selection policy rule.

In some embodiments of the present disclosure, the backend UE route selection policy rule further includes rule precedence; and the matching a target backend UE route selection policy rule from the backend UE route selection policy rule for the traffic of the backend UE includes: matching the target backend UE route selection policy rule from the backend UE route selection policy rules according to an order of the rule precedence in the backend UE route selection policy rules.

In some embodiments of the present disclosure, the executing, when the target backend UE route selection policy rule is matched for the traffic of the backend UE, a target route selection descriptor in the target backend UE route selection policy rule includes: if the target backend UE route selection policy rule further includes a target route selection validity condition, executing the target route selection descriptor when the traffic of the backend UE satisfies the target route selection validity condition.

In some embodiments of the present disclosure, the executing, when the target backend UE route selection policy rule is matched for the traffic of the backend UE, a target route selection descriptor in the target backend UE route selection policy rule includes: if a target protocol data unit session matching a route selection policy rule corresponding to the traffic of the backend UE exists, transmitting a service flow corresponding to the traffic of the backend UE on the target protocol data unit session, or initiating an update procedure for the target protocol data unit session; and if no target protocol data unit session matching the route selection policy rule corresponding to the traffic of the backend UE exists, initiating a procedure to establish the target protocol data unit session.

In some embodiments of the present disclosure, the method further includes: reporting target backend UE route selection policy rule reporting information matching the traffic of the backend UE, the target backend UE route selection policy rule reporting information including a matched target backend UE route selection policy rule, and the target backend UE route selection policy rule reporting information reported by the terminal includes at least one of a connection capability, a rule identifier, or backend device indication information.

Embodiments of the present disclosure provide a data transmission method. The method is performed by a policy control function network element (e.g., a network processing device), and the method includes: generating a UE route selection policy rule, the UE route selection policy rule including backend UE route selection policy rules, each backend UE route selection policy rule including traffic description information and a route selection descriptor, the traffic description information being configured for describing traffic information of a backend UE, the backend UE accessing a mobile network through a terminal, and the route selection descriptor being configured for performing, for traffic of the backend UE that matches the traffic description information, route selection described in the route selection descriptor; and transmitting the UE route selection policy rule to the terminal.

Embodiments of the present disclosure provide a terminal (e.g., a communication device), including: a receiving unit, configured to receive a UE route selection policy rule, the UE route selection policy rule including backend UE route selection policy rules, each backend UE route selection policy rule including traffic description information and a route selection descriptor, the traffic description information being configured for describing traffic information of a backend UE, the backend UE accessing a mobile network through the terminal, and the route selection descriptor being configured for performing, for traffic of the backend UE that matches the traffic description information, route selection described in the route selection descriptor.

Embodiments of the present disclosure provide a policy control function network element (e.g., a network processing device), including: a processing unit, configured to generate a UE route selection policy rule, the UE route selection policy rule including backend UE route selection policy rules, each backend UE route selection policy rule including traffic description information and a route selection descriptor, the traffic description information being configured for describing traffic information of a backend UE, the backend UE accessing a mobile network through a terminal, and the route selection descriptor being configured for performing, for traffic of the backend UE that matches the traffic description information, route selection described in the route selection descriptor; and a transmission unit, configured to transmit the UE route selection policy rule to the terminal.

Embodiments of the present disclosure provide a communication device, including: one or more processors; and a memory, configured to store one or more programs, the one or more programs, when executed by the one or more processors, causing the communication device to implement the data transmission method according to the embodiments of the present disclosure.

Embodiments of the present disclosure provide a non-transitory computer-readable storage medium, having a computer program stored therein, the computer program, when executed on a computer, causing the computer to implement the data transmission method according to the embodiments of the present disclosure.

Embodiments of the present disclosure provide a computer program product, including a computer program, the computer program, when executed by a computer, implementing the data transmission method according to the embodiments of the present disclosure.

### BRIEF DESCRIPTION OF THE DRAWINGS

FIG. 1 is a schematic architectural diagram of a communication system according to an embodiment of the present disclosure.

FIG. 2 is a system architecture diagram of a 5G network according to an embodiment of the present disclosure.

FIG. 3 shows a flowchart of a data transmission method according to an embodiment of the present disclosure.

FIG. 4 shows a schematic interaction diagram of a data transmission method according to an embodiment of the present disclosure.

FIG. 5 shows a schematic interaction diagram of a data transmission method according to another embodiment of the present disclosure.

FIG. 6 shows a block diagram of a terminal according to an embodiment of the present disclosure.

FIG. 7 shows a block diagram of a policy control function network element according to an embodiment of the present disclosure.

FIG. 8 shows a schematic structural diagram of a communication device according to an embodiment of the present disclosure.

### DETAILED DESCRIPTION

To describe the objectives, technical solutions, and advantages of the present disclosure, embodiments according to the present disclosure are described below with reference to the accompanying drawings. In the accompanying drawings, the same reference numerals represent the same or similar elements throughout the disclosure. Embodiments described herein are merely illustrative and are not construed as limiting the scope of the present disclosure. Other embodiments may fall within the scope of the present disclosure.

Descriptions of terms in this disclosure are provided as examples only and are not intended to limit the scope of the disclosure.

The use of “at least one of” or “one of” in the disclosure is intended to include any one or a combination of the recited elements. For example, references to at least one of A, B, or C; at least one of A, B, and C; at least one of A, B, and/or C; and at least one of A to C are intended to include only A, only B, only C or any combination thereof. References to one of A or B and one of A and B are intended to include A or B or (A and B). The use of “one of” does not preclude any combination of the recited elements when applicable, such as when the elements are not mutually exclusive.

In one or more embodiments of the present disclosure, the term “module” or “unit” refers to a computer program or a part of a computer program having a predetermined function, which works together with other related parts to achieve a predetermined objective, and may be implemented fully or partially by using software, hardware (such as a processing circuit or a memory), or a combination thereof. Similarly, one or more processors (or one or more memories) may be configured to implement one or more modules or units. In addition, each module or unit may be a part of an overall module or unit including a function of the module or unit.

The technical solutions in one or more embodiments of the present disclosure may be applied to various communication systems, for example: a global system of mobile communication (GSM) system, a code division multiple access (CDMA) system, wideband code division multiple access (WCDMA) system, a general packet radio service (GPRS), a long term evolution (LTE) system, an LTE frequency division duplex (FDD) system, an LTE time division duplex (TDD), a universal mobile telecommunication system (UMTS), a worldwide interoperability for microwave access (WiMAX) communication system, a 5G system, or a future evolved mobile communication system.

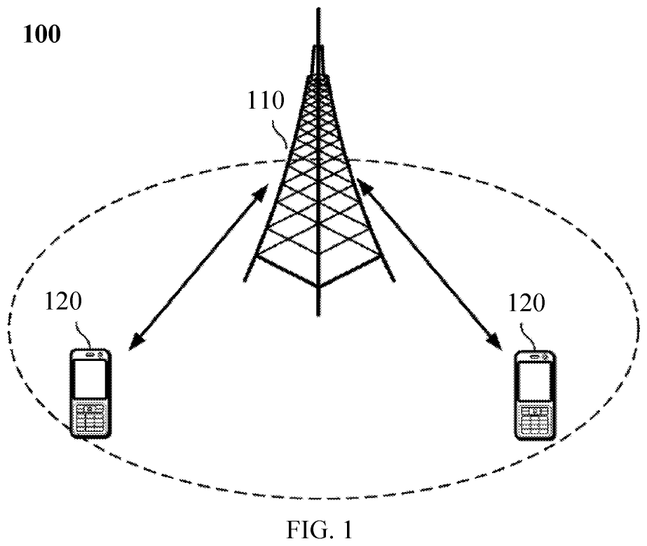

In some examples, a communication system 100 to which an embodiment of the present disclosure is applied is shown in FIG. 1. The communication system 100 may include a network device 110 (also referred to as a network processing device or a network element in some examples), where the network device 110 may be a device communicating with a terminal 120 (also referred to as a terminal device, a communication terminal, or user equipment in some examples). The network device 110 may provide communication coverage for a specific geographical area, and may communicate with terminals located within the coverage area. In some embodiments, the network device 110 may be a base transceiver station (BTS) in a GSM system or a CDMA system, a nodeB (NB) in a WCDMA system, an evolutional nodeB (eNB or eNodeB) in an LTE system, a base station in a 5G communication system, or a wireless controller in a cloud radio access network (CRAN), or the network device may be a mobile switching center, a relay station, an access point, an in-vehicle device, a wearable device, a hub, a switch, a bridge, a router, a network side device in a 5G network, a network device in a future evolved public land mobile network (PLMN), or the like.

The communication system 100 further includes at least one terminal 120 located within the coverage area of the network device 110. The “terminal” used herein includes, but is not limited to, devices connected via a wired line, such as via public switched telephone network (PSTN), a digital subscriber line (DSL), a digital cable, or a direct cable; and/or another data connection/network; and/or via a wireless interface, such as for a cellular network or a wireless local area network (WLAN), a digital television network such as a DVB-H network, a satellite network, or an AM-FM broadcast transmitter; and/or an apparatus of another terminal that is configured to receive/transmit communication signals; and/or an Internet of things (IOT) device. A terminal configured to communicate via a wireless interface may be referred to as a “wireless communication terminal”, a “wireless terminal”, or a “mobile terminal”. Examples of the mobile terminal include, but are not limited to, a satellite or cellular phone; a personal communications system (PCS) terminal that may combine cellular radiotelephony with data processing, facsimile, and data communication capabilities; a personal digital assistant (PDA) that may include a radiotelephone, a pager, Internet/Intranet access, a Web browser, a notepad, a calendar, and/or a global positioning system (GPS) receiver; and a laptop and/or palmtop receiver or another electronic device including a radiotelephone transceiver. The terminal may be an access terminal, a user equipment (UE), a user unit, a user station, a mobile station, a mobile platform, a remote station, a remote terminal, a mobile device, a user terminal, a terminal, a wireless communication device, a user agent, or a user apparatus. The access terminal may be a cellular phone, a cordless phone, a session initiation protocol (SIP) phone, a wireless local loop (WLL) station, a PDA, a handheld device having a wireless communication function, a computing device, or another processing device connected to a wireless modem, an in-vehicle device, a wearable device, a terminal in a 5G network, a terminal in a future evolved PLMN, or the like.

In some embodiments, device to device (D2D) communication may be performed between terminals 120.

FIG. 1 shows one network device and two terminals. In some embodiments, the communication system 100 may include a plurality of network devices and coverage of each network device may include another quantity of terminals. This is not limited in the embodiments of the present disclosure.

In some embodiments, the communication system 100 may further include other network elements such as a policy control function network element, an access and mobility management function network element, a session management function network element, and a user plane function network element. This is not limited in the present disclosure.

In some embodiments of the present disclosure, a device having a communication function in the network/system may be referred to as a communication device. The communication system 100 shown in FIG. 1 is used as an example. The communication device may include a network device 110 and a terminal 120 having a communication function. The network device 110 and the terminal 120 may be the specific devices described above, and are not described herein again.

The terms “system” and “network” in this specification are often used interchangeably. The term “and/or” in this specification is merely an association relationship for describing associated objects, and indicates that three relationships may exist. For example, A and/or B may indicate the following three cases: Only A exists, both A and B exist, and only B exists.

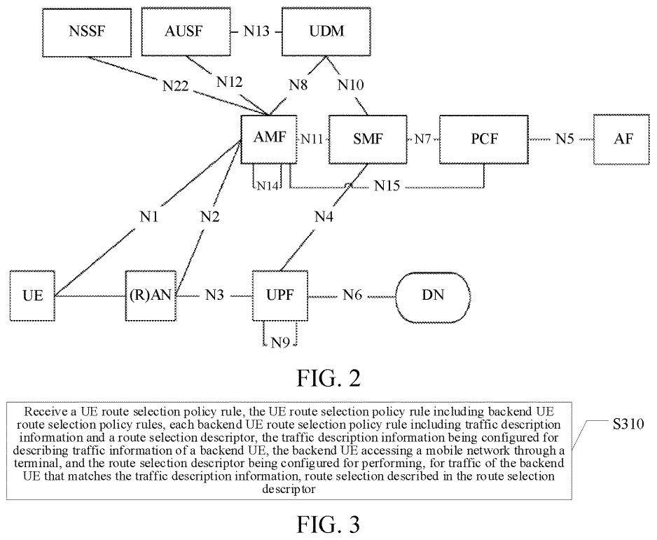

FIG. 2 is a system architecture diagram of a 5G network according to an embodiment of the present disclosure. As shown in FIG. 2, devices involved in a 5G network system include: a UE, a radio access network (RAN), a user plane function (UPF) network element, a data network (DN), an access and mobility management function (AMF) network element, a session management function (SMF) network element, a policy control function (PCF) network element, an application function (AF) network element, an authentication server function (AUSF) network element, and a unified data management (UDM) network element.

As shown in FIG. 2, network elements (e.g., implemented as one or more network processing devices) related to a policy include the PCF, AMF, SMF, RAN, and UE. The SMF is responsible for executing a session-related policy. The AMF is responsible for executing access policies and UE-related policies. Policy delivery and update on both the network elements (the AMF and the SMF) are managed by the PCF.

For a UE policy, a container may be used between the PCF and the UE to monitor information related to the UE policy, including content of the UE policy, a UE policy identifier, and the like. In an uplink direction, the container is transmitted by the UE to the AMF through a non-access-stratum (NAS) message, and the AMF continues to transparently transmit (without interpreting or modifying) the container to the PCF. In a downlink direction, the process is reversed: the PCF transmits the container to the AMF, and the AMF then transparently transmits the container to the UE through a NAS message.

The UE policy includes a UE route selection policy (URSP). The URSP includes a plurality of policy rules (referred to as URSP Rules or UE route selection policy rules), and each URSP Rule includes a traffic descriptor and a set of route selection descriptors (RSDs). The traffic descriptor in the URSP indicates a specific service. One traffic descriptor may have one or more RSDs, and each RSD corresponds to an attribute of one PDU session. In other words, service data corresponding to the traffic descriptor may be carried over the PDU session corresponding to the RSD.

Related content of the URSP in related technology is shown in Table 1 and Table 2 below.

TABLE 1
URSP Rule

| | | | PCF allowed to | |
|---|---|---|---|---|
| | | | perform | |
| Information | | | modification in | |
| name | Description | Category | the UE context | Scope |
| Rule | Indicates an execution order of | Mandatory | Yes | UE |
| precedence | the URSP rule in the UE | (Note 1) | | context |
| Traffic | This section defines traffic | Mandatory | | |
| descriptor | descriptor components of the | (Note 3) | | |
| | URSP rule | | | |
| Application | I consists of OSId and | Non- | Yes | UE |
| descriptor | OSAppId(s) (Note 2) | mandatory | | context |
| IP descriptor | A target IP 3-tuple (an IP | Non- | Yes | UE |
| (Note 5) | address or an IPV6 network | mandatory | | context |
| | prefix, a port number, or a | | | |
| | protocol ID of a protocol above | | | |
| | IP) | | | |
| Domain | An FQDN or a regular | Non- | Yes | UE |
| descriptor | expression used as a domain | mandatory | | context |
| | matching condition (Note 6) | | | |
| Non-IP | Destination information | Non- | Yes | UE |
| descriptor | descriptor of non-IP traffic | mandatory | | context |
| (Note 5) | | | | |
| Data network | This matches DNN information | Non- | Yes | UE |
| name | provided by an application | mandatory | | context |
| Connection | This matches information | Non- | Yes | UE |
| capability | provided by a UE application | mandatory | | context |
| | when requesting a network | | | |
| | connection having a specific | | | |
| | capability or service category | | | |
| | (Note 4) | | | |
| Route | A list of route selection | Mandatory | | |
| selection | descriptors Components of a | | | |
| descriptor list | route selection descriptor are | | | |
| | shown in Table 6.6.2.1-3 | | | |

In Table 1 above, the rule precedence determines an order in which the UE uses the URSP rules. The traffic descriptor is a traffic descriptor configured for specifying matching criteria, describes traffic information that conforms to the URSP rule, and includes one or more components. In some embodiments, the traffic descriptor includes an application descriptor, an IP descriptor (a target IP), a domain descriptor (a target fully qualified domain name (FQDN)), a non-IP descriptor (descriptor information of a non-IP service), a data network name (DNN), and a connection capability. The traffic descriptor is used by the UE to perform application matching. A target IP 3-tuple (an IP address or an IPv6 network prefix, a port number, or a protocol ID of a protocol above IP). The connection capability may be: “ims”, “mms”, “internet”, or the like. When any component in the traffic descriptor can match corresponding information from an application, the URSP rule is applicable. When the corresponding information from the application does not match any value in the traffic descriptor component, the URSP rule is not applicable.

TABLE 2
RSD

| | | | PCF allowed to | |
|---|---|---|---|---|
| | | | perform | |
| Information | | | modification in | |
| name | Description | Category | the URSP | Scope |
| RSD precedence | Determine an order of | Mandatory | Yes | UE |
| | application route selection | (Note 1) | | context |
| | descriptors | | | |
| Route selection | This section defines the route | Mandatory | | |
| component | selection component | (Note 2) | | |
| SSC mode | A single value of an SSC | Non- | Yes | UE |
| selection | mode (Note 5) | mandatory | | context |
| Network slice | A list of one or more pieces | Non- | Yes | UE |
| selection | of S-NSSAI | mandatory | | context |
| | | (Note 3) | | |
| DNN selection | A list of one or more DNN | Non- | Yes | UE |
| | values | mandatory | | context |
| PDU session type | A single value of a PDU | Non- | Yes | UE |
| selection | session type | mandatory | | context |
| | | (Note 8) | | |
| Non-seamless | Indicates whether traffic of a | Non- | Yes | UE |
| offload indication | matched application is to be | mandatory | | context |
| | offloaded to non-3GPP | (Note 4) | | |
| | access outside a PDU session | | | |
| ProSe layer 3 UE- | Indicates whether the traffic | Non- | Yes | UE |
| to-network relay | of the matched application is | mandatory | | context |
| offload indication | to be transmitted to a network | (Note 4) | | |
| | relay outside the PDU | | | |
| | session through a ProSe | | | |
| | Layer 3 UE | | | |
| Access type | Indicates a preferred access | Non- | Yes | UE |
| preference | type (3GPP, non-3GPP, or | mandatory | | context |
| | multi-access) when the UE | | | |
| | establishes the PDU session | | | |
| | for the matched application | | | |
| PDU session pair | An indication of being shared | Non- | Yes | UE |
| ID | by a redundant PDU session, | mandatory | | context |
| | as described in clause | | | |
| | 5.33.2.1 of TS 23.501[2] | | | |
| RSN | An RSN described in clause | Non- | Yes | UE |
| | 5.33.2.1 of TS 23.501[2] | mandatory | | context |
| Route selection | This section defines a route | Non- | | |
| validation criteria | validation criterion | mandatory | | |
| (Note 6) | component | | | |
| Time window | A time window allowed for | Non- | Yes | UE |
| | traffic matching If current | mandatory | | context |
| | time is not within the time | | | |
| | window, the RSD is not | | | |
| | considered valid | | | |
| Location criteria | A UE location allowed for | Non- | Yes | UE |
| | service matching If the UE | mandatory | | context |
| | location does not match the | | | |
| | location criteria, the RSD | | | |
| | rule is considered invalid | | | |

In Table 2 above, the route selection descriptor precedence (RSD precedence) determines an order in which RSDs are used. Other RSDs are used when (e.g., only when) a higher-precedence RSD with cannot be used. The route selection components describe various network resources that may be used by an application, include one or more components, and may include service and session continuity (SSC) mode selection (SSC Mode Selection), network slice selection, DNN Selection, protocol data unit (PDU) session type selection, non-seamless offload indication, ProSe Layer 3 UE-to-network relay offload indication, access type preference, PDU session pair ID, RSN, and route selection validation criteria.

The route selection validation criteria, also referred to as route selection validity conditions, describe corresponding validation conditions. The criteria are optional parameters, including a time window (which may also be referred to as a valid time window) and location criteria. The time window defines a time in which the RSD is valid, and may also be understood as a time in which the service traffic is allowed. When the current time is not within the time window, the RSD is invalid. The location criteria defines UE locations where the RSD is valid, and may also be understood as UE locations where the service traffic is allowed. When a current location of the UE does not match the locations defined in the location criteria, the RSD is invalid. In other words, if the current time is not within the time window or the UE location does not match the location criteria, that is, if any one of the route selection validation criteria is not satisfied, the corresponding RSD is considered invalid.

SSC mode selection is an SSC mode used by the UE to select a corresponding SSC mode for a matched application, and DNN selection is a DNN used by the UE to select a corresponding DNN for a matched application. PDU session type selection is a PDU session type used by the UE to select a corresponding session type for a matched application. Access type preference, which may also be referred to as access type precedence, indicates a preferred access type (3GPP, non-3GPP, or multi-access) if the UE needs to establish a PDU session for a matched application.

The SSC mode, the single network slice selection assistance information (S-NSSAI), the PDU session type, and the DNN are all parameters related to a PDU session attribute.

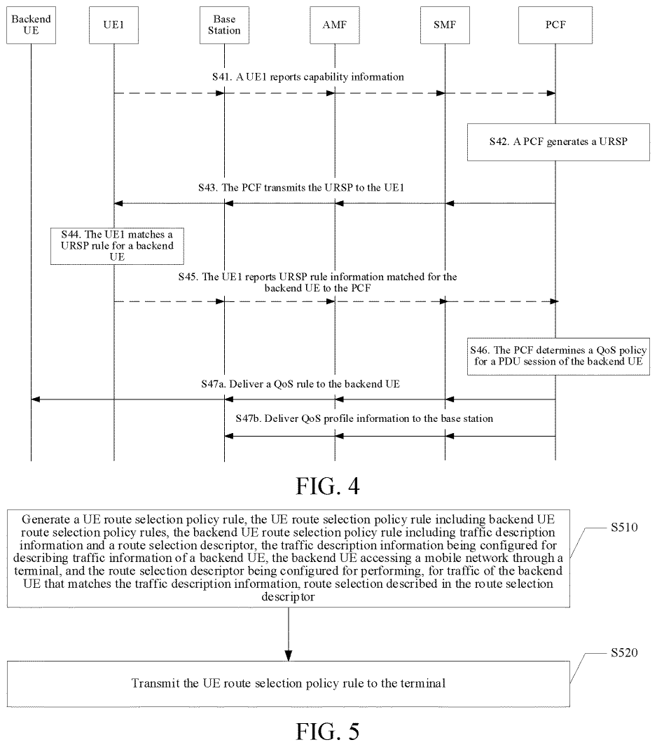

In related technology, the URSP rule is formulated and delivered only for this terminal (e.g., labeled as UE1 in FIG. 4), and is stored and used only on this terminal. In this way, a backend UE accessing the network through a hotspot can only use a default QoS flow of a default PDU session of the UE1 for data transmission, and cannot be configured with a specific route selection policy and QoS rule. In other words, in related technology, this terminal UE1 cannot distinguish data of the backend UE accessing the network through a hotspot of the UE1, nor map the data to a specific QoS flow to ensure network quality of the backend UE. In this disclosure, the URSP rule is enhanced, so that a route selection policy for data of the backend UE accessing the mobile network through the hotspot of the UE1 can be enhanced, to ensure network quality of service data transmission of the backend UE. A connection manner between the UE1 and the backend UE accessing the mobile network through the UE1 is not limited in this disclosure. A Wi-Fi connection, a Bluetooth connection, a USB connection, or a cellular connection manner such as 4G or 5G may be used.

A method provided in an embodiment of FIG. 3 may be performed by a terminal (for example, the UE1 in FIG. 4). As shown in FIG. 3, the method provided in one or more embodiments may include the following operations.

In S310, the terminal receives UE route selection policy rule information (e.g., including a UE route selection policy rule), the UE route selection policy rule including backend UE route selection policy rules, each backend UE route selection policy rule including traffic description information and a route selection descriptor (e.g., route selection information), the traffic description information being configured for describing traffic information of a backend UE, the backend UE accessing a mobile network through the terminal, and the route selection descriptor being configured for performing, for traffic of the backend UE that matches the traffic description information, route selection described in the route selection descriptor.

In some examples, UE route selection policy rule information is received by processing circuitry of a terminal device. In some examples, the UE route selection policy rule information includes a traffic descriptor and a backend UE descriptor, and the backend UE descriptor is included in the traffic descriptor or the UE route selection policy rule information independent of the traffic descriptor. In some examples, the backend UE descriptor includes traffic description information and a route selection information, the traffic description information indicating one or more of a backend device type, a domain descriptor, an Internet protocol descriptor, or connection capability information.

In some examples, whether the UE route selection policy rule information matches a backend UE connected to the terminal device is determined. In some examples, when the UE route selection policy rule information matches the backend UE, communication between the backend UE and a mobile network through the terminal device is configured by the processing circuitry of the terminal device based on the backend UE descriptor.

In at least one aspect, the terminal is connected to a backend UE, and enables the backend UE to access the mobile network through the terminal. The terminal is referred to as a UE1 or this terminal in this disclosure. The backend UE is a terminal accessing the mobile network through the terminal such as the UE1.

In one embodiment, the terminal may receive a UE route selection policy rule (e.g., UE route selection policy rule information) transmitted by a PCF network element.

In an embodiment, the UE route selection policy rule includes a traffic descriptor, the traffic descriptor including a connected backend UE descriptor, the connected backend UE descriptor serving as traffic description information of a connected backend UE. The UE route selection policy rule including the connected backend UE descriptor in the traffic descriptor is the backend UE route selection policy rule.

In an embodiment, the backend UE route selection policy rule further includes rule precedence. For example, the UE route selection policy rule information includes rule precedence information indicating execution precedence of the UE route selection policy rule information in the terminal device.

In some examples, the traffic description information includes backend device type information indicating that the backend UE descriptor is applicable to the backend device type that includes an unmanned aerial vehicle, a wearable computing device, or a handheld computing device. In some examples, the backend UE descriptor is included in the traffic descriptor, and one or more parameters in the traffic descriptor that contradict the backend UE descriptor are invalid for configuring the communication between the backend UE and the mobile network through the terminal device. In some examples, the backend UE descriptor is included in the UE route selection policy rule information independent of the traffic descriptor, and the traffic descriptor is empty or invalid for configuring the communication between the backend UE and the mobile network through the terminal device.

In an embodiment, when the traffic descriptor includes both the connected backend UE descriptor and other related parameters, the other related parameters are valid for traffic of this terminal, and the connected backend UE descriptor is valid for (e.g., only for) traffic of a backend UE connected to this terminal.

In an embodiment, when the traffic descriptor includes both the connected backend UE descriptor and other related parameters, any parameters included in the traffic descriptor other than the connected backend UE descriptor are invalid. Alternatively, the traffic descriptor does not include any parameters other than the connected backend UE descriptor.

In an embodiment, the UE route selection policy rule includes rule precedence, a traffic descriptor, and a connected backend UE traffic descriptor, the connected backend UE traffic descriptor serving as the traffic description information of a connected backend UE. The UE route selection policy rule including the traffic descriptor and the connected backend UE traffic descriptor is the backend UE route selection policy rule.

In an embodiment, the traffic descriptor is empty or invalid.

In an embodiment, the traffic descriptor is valid for the traffic of this terminal; and the connected backend UE traffic descriptor is valid for a backend UE connected through this terminal.

In an embodiment, the backend UE route selection policy rule is a UE route selection policy rule (which may be referred to as a Tether-URSP rule) for the backend UE, and the backend UE route selection policy rule includes a traffic descriptor, the traffic descriptor serving as traffic description information of a connected backend UE.

In some embodiments, the UE may receive a URSP rule. For example, the URSP rule received by the UE includes a traffic descriptor, a connected backend UE descriptor is added to the traffic descriptor, and the connected backend UE descriptor serves as the traffic description information of a connected backend UE. In this case, the URSP rule may also be referred to as a backend UE route selection policy rule. For another example, the URSP rule received by the UE includes a connected backend UE traffic descriptor in parallel with a traffic descriptor, and the connected backend UE traffic descriptor serves as the traffic description information of a connected backend UE. In this case, the URSP rule may also be referred to as a backend UE route selection policy rule. In some other embodiments, the UE may receive a Tether-URSP rule, that is, a URSP rule specifically for the backend UE, and a traffic descriptor included in the Tether-URSP rule serves as the traffic description information for connecting to the backend UE.

In an embodiment, the backend UE route selection policy rule further includes rule precedence, the rule precedence indicating an execution order of the backend UE route selection policy rule in the terminal.

In an embodiment, the traffic description information includes at least one of the following:
a device type, indicating a device type of the backend UE;
a domain descriptor;
an Internet protocol descriptor; or
a connection capability.

In some embodiments, when the connected backend UE descriptor serves as the traffic description information, the connected backend UE descriptor is included in the traffic descriptor, and the connected backend UE descriptor includes at least one of the following: a device type; a domain descriptor; an Internet protocol descriptor; or a connection capability. In some other embodiments, when the URSP rule includes a traffic descriptor and a connected backend UE traffic descriptor that are in parallel, and the connected backend UE traffic descriptor serves as the traffic description information for connecting to the backend UE, the connected backend UE traffic descriptor includes at least one of the following: a device type; a domain descriptor; an Internet protocol descriptor; or a connection capability. In some other embodiments, when the backend UE route selection policy rule is a UE route selection policy rule for the backend UE, the backend UE route selection policy rule includes a traffic descriptor, and the traffic descriptor serves as the traffic description information, the traffic descriptor includes at least one of the following: a device type; a domain descriptor; an Internet protocol descriptor; or a connection capability.

In an embodiment, the backend UE route selection policy rule further includes a route selection validity condition, the route selection validity condition indicating that the route selection descriptor (e.g., route selection information) is valid when the backend UE satisfies the route selection validity condition. In some examples, the backend UE descriptor includes route selection validity condition information indicating that the route selection information is valid when the backend UE satisfies the route selection validity condition information.

In an embodiment, the method in this disclosure may further include: reporting target backend UE route selection policy rule reporting information matching traffic of the backend UE, the target backend UE route selection policy rule reporting information including a matched target backend UE route selection policy rule. The target backend UE route selection policy rule reporting information reported by the terminal includes at least one of the following:
a connection capability;
a rule identifier; or
backend device indication information.

In this disclosure, the backend device indication information may be a unique identifier of the backend UE, for example, may be a hardware identifier and/or a subscriber identity module (SIM) card identifier of the backend UE, which is not limited in the present disclosure. When the backend UE is a terminal having a single service (for example, an Internet of things terminal), the backend UE can be uniquely identified through the backend device indication information, and a service type or connection capability initiated by the backend UE can be determined. If a plurality of services are run on the backend UE (for example, a mobile phone), a service initiated by the backend UE may be determined according to the connection capability and/or the rule identifier.

In an embodiment, the method in one or more embodiments may further include: matching a target backend UE route selection policy rule from the backend UE route selection policy rules for the traffic of the backend UE when the backend UE accesses the mobile network through the terminal; and executing, when the target backend UE route selection policy rule is matched for the traffic of the backend UE, a target route selection descriptor in the target backend UE route selection policy rule.

In an embodiment, the backend UE route selection policy rule may further include rule precedence; and the matching a target backend UE route selection policy rule from the backend UE route selection policy rules for the traffic of the backend UE may be: matching the target backend UE route selection policy rule from the backend UE route selection policy rules according to an order of the rule precedence in the backend UE route selection policy rules.

In an embodiment, the executing, when the target backend UE route selection policy rule is matched for the traffic of the backend UE, a target route selection descriptor in the target backend UE route selection policy rule may be: if the target backend UE route selection policy rule further includes a target route selection validity condition, executing the target route selection descriptor when the traffic of the backend UE satisfies the target route selection validity condition.

In an embodiment, the executing, when the target backend UE route selection policy rule is matched for the traffic of the backend UE, a target route selection descriptor in the target backend UE route selection policy rule may be: if a target protocol data unit session matching a route selection policy rule corresponding to the traffic of the backend UE exists, transmitting a service flow corresponding to the traffic of the backend UE on the target protocol data unit session, or initiating an update procedure for the target protocol data unit session; and if no target protocol data unit session matching the route selection policy rule corresponding to the traffic of the backend UE exists, initiating a procedure to establish the target protocol data unit session.

In an embodiment, the method in this disclosure may further include: reporting the target backend UE route selection policy rule reporting information matching the traffic of the backend UE, the target backend UE route selection policy rule reporting information including at least one of a connection capability, a rule identifier, or backend device indication information.

In an embodiment, the method in this disclosure may further include: reporting capability information of the terminal, the capability information indicating whether the terminal supports executing the backend UE route selection policy rule for the backend UE. For example, capability information of the terminal device may be reported. In some examples, the capability information indicates whether the terminal device supports a function of configuring the communication for the backend UE based on the UE route selection policy rule information that matches the backend UE.

The data transmission method provided in this disclosure enhances the URSP rule, and the backend UE URSP rule is generated for the backend UE accessing the mobile network through this terminal, so that a service flow of the backend UE accessing the mobile network through the terminal may select a PDU session (in some embodiments, bind a QoS flow), thereby better supporting network quality assurance for the service flow of the backend UE accessing the mobile network through the terminal.

FIG. 4 shows a schematic interaction diagram of a data transmission method according to an embodiment of the present disclosure. As shown in FIG. 4, the method provided in this disclosure may include the following operations.

In some embodiments, in S41, a UE1 reports capability information to a PCF.

For example, the UE1 may report the capability information to the PCF sequentially through a base station, an AMF, and an SMF.

For any one of the following plurality of implementations of a backend UE URSP rule provided in an embodiment of FIG. 5, if the UE1 supports executing a specific URSP rule (that is, a target backend UE URSP rule) for a connected backend device, the UE1 may report the capability information of the UE1 in a procedure such as a registration procedure, a mobility management procedure, or a terminal capability reporting procedure, to indicate that the UE1 supports executing the URSP rule (that is, the backend UE URSP rule) for the backend device.

In S42, the PCF generates a URSP.

In some embodiments, after receiving the reported capability information, the PCF generates a URSP rule for the backend UE (referred to as backend UE URSP rule) according to the reported capability information. The PCF may determine, according to the received capability information reported by the UE1, whether the UE1 supports the URSP rule for the backend UE. If the UE1 supports the URSP rule, the PCF generates the URSP rule for the backend UE; and if the UE1 does not support the URSP rule, the PCF does not generate the URSP rule for the backend UE.

S41 above is a non-limiting example, that is, the PCF may also directly generate the URSP for the backend UE.

In S43, the PCF transmits the generated URSP for the backend UE to the UE1.

In some embodiments, the PCF transmits the generated URSP to the AMF. The PCF may transmit the generated URSP for the backend UE to the AMF. After receiving the URSP, the AMF transmits the URSP to the UE1 through the base station/RAN. In this disclosure, the AMF may directly forward the URSP for the backend UE to the UE1 by using an NAS message, but this disclosure is not limited thereto.

In some embodiments, the PCF transmits the generated URSP to the SMF. The SMF then transmits the URSP to the AMF. The AMF then transmits the URSP to the base station. The base station then transmits the URSP to the UE1.

In S44, the UE1 matches a URSP rule for the backend UE.

The UE1 associates, based on the received URSP for the backend UE, application data of the backend UE with a corresponding PDU session for transmission according to the URSP for the backend UE, and the mechanism is as follows: When an application layer of the backend UE transmits data, the UE1 receives the data of the UE, and checks, according to the data being from a connected backend UE, whether a feature of the application data of the backend UE matches traffic description information of one of backend UE URSP rules by using a backend UE URSP rule in the URSP. A checking order is determined according to rule precedence in the backend UE URSP rule. In other words, the UE1 sequentially checks a matching status based on an order of the rule precedence. When the traffic description information of one backend UE URSP rule is matched, a PDU session is bound by using an RSD list under the backend UE URSP rule. When the backend UE URSP rule is matched, the UE1 searches for an appropriate PDU session according to a precedence order in the RSD. A higher-precedence RSD is used in this example. If a parameter in the RSD has one or more values, the UE1 selects a combination of parameters to search for the existence of the PDU session:
1) if the PDU session exists, the application data of the backend UE is bound to the session for transmission;
2) if the PDU session does not exist, the UE1 triggers establishment of the PDU session, and the UE1 reports an attribute parameter of the PDU session in an establishment request message; further,
2.1) if the session is successfully established, the UE1 binds the application data of the backend UE to the session for transmission;
2.2) if the session is not successfully established, the UE1 searches again for the existence of the PDU session based on another parameter combination in the RSD or a parameter combination in a secondary-precedence RSD (that is, repeating operation 1); and
if no appropriate PDU session can be found for binding according to all matched backend UE URSP rules, the UE1 searches for, according to a precedence order, whether traffic description information in a secondary-precedence backend UE URSP rule can match an application data flow feature of the backend UE. When the matching is successful, the foregoing process is repeated.

In some embodiments, in S45, the UE1 reports URSP rule information matched for the backend UE (that is, the target backend UE URSP rule information) to the PCF sequentially through the base station, the AMF, and the SMF.

For any one of the following plurality of implementations of the backend UE URSP rule provided in the embodiment of FIG. 5, if the UE1 matches a specific backend UE URSP rule (that is, a target backend UE URSP rule) for a connected backend device, the UE1 may report the matched backend UE URSP rule to a network. The reported information may be: one or more of a connection capability, a rule identifier (that is, an identifier of the target backend UE URSP rule), backend device indication information, or the like. A network element (e.g., implemented in a network processing device) in the network, for example, the PCF, may determine, according to information about the reported target backend UE URSP rule, that the backend UE/backend device is currently accessed, and may deliver a specific QoS policy (that is, a target QoS policy), which may include a QoS rule, QoS profile (configuration file) information, and the like, for a PDU session (referred to as a target PDU session for distinguishment) according to a policy.

In S46, the PCF determines the QoS policy for a PDU session of the backend UE.

In S47a, the PCF delivers the QoS rule to the backend UE sequentially through the SMF, the AMF, and the base station.

In S47b, the PCF delivers the QoS profile information to the base station sequentially through the SMF and the AMF.

The data transmission method provided in of FIG. 5 may be performed by a PCF network element, but this disclosure is not limited thereto. As shown in FIG. 5, the method provided in this disclosure may include the following operations.

In S510, the PCF generates a UE route selection policy rule, the UE route selection policy rule (e.g., UE route selection policy rule information) including backend UE route selection policy rules, each backend UE route selection policy rule including traffic description information and a route selection descriptor (e.g., route selection information), the traffic description information being configured for describing traffic information of a backend UE, the backend UE accessing a mobile network through a terminal, and the route selection descriptor being configured for performing, for traffic of the backend UE that matches the traffic description information, route selection described in the route selection descriptor.

In some examples, capability information of a terminal device is received by a network processing device. In some examples, the capability information indicates that the terminal device supports a function of configuring communication between a backend UE and a mobile network through the terminal device based on a backend UE descriptor. In some examples, UE route selection policy rule information is generated by the network processing device. In some examples, the UE route selection policy rule information includes a traffic descriptor and the backend UE descriptor included in the traffic descriptor or the UE route selection policy rule information independent of the traffic descriptor, the backend UE descriptor including traffic description information and a route selection information, and the traffic description information indicating one or more of a backend device type, a domain descriptor, an Internet protocol descriptor, or connection capability information.

In this disclosure, the terminal refers to a terminal connected to a backend UE, and enables the backend UE to access the mobile network through the terminal. The terminal is represented as a UE1 or this terminal below. For example, the UE1 may share a hotspot of the UE1, to enable the backend UE to access the mobile network, but this disclosure is not limited thereto. The backend UE is a terminal accessing the mobile network through the terminal such as the UE1. Types of the backend UE and the terminal are not limited in this disclosure, and may be, for example, any one or more of a notebook computer, a tablet computer, a mobile phone, a drone, a robot, or an Internet of things device.

The UE route selection policy (URSP) may include one or more (two or more) URSP rules, and each URSP rule may include one or more route selection descriptors (RSDs). The URSP may be configured for mapping a specific service flow to a corresponding data transmission session by the UE (for example, the UE1 and/or the backend UE). For example, the PCF may generate a plurality of URSP rules in a core network. For the UE1, each URSP rule may include a traffic descriptor and a route selection descriptor (RSD). When an application on the UE1 is started, a corresponding URSP may be determined by matching, according to a traffic characteristic of the application started on the UE1, the traffic descriptor in the URSP rule generated by the core network. Each URSP rule may include one or more RSDs, and corresponding RSD precedence may be configured for different RSDs in each URSP rule according to a service requirement and a service type. After the corresponding URSP is matched, the UE1 may select a corresponding RSD according to generated RSD precedence of each RSD, and transmit data (referred to as service data or application data) of the application on a data transmission session corresponding to the RSD.

In this disclosure, the URSP rule includes a backend UE URSP rule. The backend UE URSP rule refers to a URSP rule that is set for the backend UE, or traffic description information for the backend UE is newly added to the URSP rule that is set for this terminal, so that this terminal can match a corresponding URSP rule for the backend UE.

In an embodiment, the backend UE route selection policy rule includes a traffic descriptor, the traffic descriptor including a connected backend UE descriptor, the connected backend UE descriptor serving as the traffic description information of a connected backend UE.

In an embodiment, the backend UE route selection policy rule may further include rule precedence. For example, the UE route selection policy rule information includes rule precedence information indicating execution precedence of the UE route selection policy rule information in the terminal device.

In some examples, the traffic description information includes backend device type information indicating that the backend UE descriptor is applicable to the backend device type that includes an unmanned aerial vehicle, a wearable computing device, or a handheld computing device. In some examples, the backend UE descriptor is included in the traffic descriptor, and one or more parameters in the traffic descriptor that contradict the backend UE descriptor are invalid for configuring the communication between the backend UE and the mobile network through the terminal device. In some examples, the backend UE descriptor is included in the UE route selection policy rule information independent of the traffic descriptor, and the traffic descriptor is empty or invalid for configuring the communication between the backend UE and the mobile network through the terminal device.

In some examples, the backend UE descriptor includes route selection validity condition information indicating that the route selection information is valid when the backend UE satisfies the route selection validity condition information.

In some embodiments, when the traffic descriptor includes both the connected backend UE descriptor and other related parameters, the other related parameters are valid for traffic of this terminal, and the connected backend UE descriptor is valid for (e.g., only for) traffic of a backend UE connected to this terminal. In some other embodiments, when the traffic descriptor includes both the connected backend UE descriptor and other related parameters, any parameters included in the traffic descriptor other than the connected backend UE descriptor are invalid. Alternatively, the traffic descriptor does not include any parameters other than the connected backend UE descriptor.

In an embodiment, the traffic description information includes at least one of the following:
a device type, indicating a device type of the backend UE;
a domain descriptor;
an Internet protocol (IP) descriptor; or
a connection capability.

In some embodiments, the following field content is added to a traffic descriptor of the URSP rule:
a connected backend UE descriptor, where the connected backend UE descriptor includes traffic description information for a backend UE connected to the UE1 (in this case, the URSP rule to which the connected backend UE descriptor is added is referred to as the backend UE URSP rule).

In an example, the connected backend UE descriptor may further include the following information:
a device type: a device type of the backend UE, such as a drone, a smartwatch, or an extended reality (XR) device;
a domain descriptor: an FQDN(s) or a regular expression used as a domain matching condition;
an IP descriptor: a target IP 3-tuple (an IP address or an IPv6 network prefix, a port number, or a protocol ID of a protocol above IP); and
a connection capability: This matches information provided by a backend UE application when requesting a network connection having a specific capability or a service category. The connection capability may be: “ims”, “mms”, “internet”, or the like.

In an embodiment, when the traffic descriptor includes both the connected backend UE descriptor and other related parameters, the other related parameters are valid for traffic of this terminal, and the connected backend UE descriptor is valid for (e.g., only for) traffic of a backend UE connected to this terminal. In some other embodiments, when the traffic descriptor includes both the connected backend UE descriptor and the other related parameters, the other parameters are invalid. In other words, when the traffic descriptor includes the “connected backend UE descriptor”, only a parameter in the “connected backend UE descriptor” is valid. Alternatively, the traffic descriptor does not need to include another parameter.

When receiving a URSP rule including the “connected backend UE descriptor”, the UE1 may match a service flow for traffic of a backend UE connected through a hotspot. A matching order may be precedence of the URSP rule including the “connected backend UE descriptor”. When the UE matches a specific URSP rule for the traffic of the backend UE connected through the hotspot (the specific URSP rule is referred to as a target backend UE URSP rule), an RSD in the specific URSP rule is executed (the executed RSD in the specific URSP rule is referred to as a target RSD). Further, if the specific URSP rule includes a “route selection validity condition”, the target RSD is executed when (e.g., only when) the route selection validity condition is satisfied.

In an example, a method for executing the target RSD is: if a PDU session (referred to as a target PDU session for distinguishment) has been established for the matched URSP rule, transmitting the service flow of the backend UE on the PDU session or initiating an update procedure for the PDU session; and initiating a PDU session establishment procedure if no PDU session has been established for the matched URSP rule.

In an embodiment, the backend UE route selection policy rule includes rule precedence, a traffic descriptor, and a connected backend UE traffic descriptor, the connected backend UE traffic descriptor serving as traffic description information of a connected backend UE.

In some other embodiments, a “connected backend UE traffic descriptor” is added to the URSP rule, that is, the “connected backend UE traffic descriptor” is parallel to the “traffic descriptor”. When the URSP rule includes the “connected backend UE traffic descriptor”, the “traffic descriptor” is invalid, and its content may be empty, or even if it contains content, the traffic descriptor is invalid. In this case, the URSP rule to which the connected backend UE traffic descriptor is added is referred to as the backend UE URSP rule.

In some other embodiments, a “connected backend UE traffic descriptor” is added to the URSP rule, that is, the “connected backend UE traffic descriptor” is parallel to the “traffic descriptor”. When the URSP rule includes the “connected backend UE traffic descriptor”, the content of the “traffic descriptor” may be empty. In this case, the URSP rule is valid for (e.g., only for) the backend UE; and when the URSP rule includes both the content of the “connected backend UE traffic descriptor” and the content of the “traffic descriptor”, the URSP rule is valid for both the traffic of this terminal and the traffic of the backend UE.

When receiving a URSP rule including the “connected backend UE traffic descriptor”, the UE1 matches a service flow for traffic of a backend UE connected through a hotspot. A matching order is precedence of the URSP rule including the “connected backend UE traffic descriptor”. When the UE matches a specific URSP rule (referred to as a target backend UE URSP rule) for the traffic of the backend UE connected through the hotspot, an RSD (a target RSD) in the specific URSP rule is executed. Further, if the specific URSP rule includes a “route selection validity condition”, the target RSD is executed when (e.g., only when) the route selection validity condition is satisfied.

In an example, the method for executing the target RSD is: if a PDU session (referred to as a target PDU session for distinguishment) has been established for the matched URSP rule, transmitting the service flow of the backend UE on the PDU session or initiating an update procedure for the PDU session; and initiating a PDU session establishment procedure if no PDU session has been established for the matched URSP rule.

In an embodiment, the backend UE route selection policy rule is a UE route selection policy rule for the backend UE, and the backend UE route selection policy rule includes a traffic descriptor, the traffic descriptor serving as traffic description information of a connected backend UE.

In an embodiment, the backend UE route selection policy rule further includes rule precedence, the rule precedence indicating an execution order of the backend UE route selection policy rule in the terminal.

In some other embodiments, a URSP rule for the backend UE (which may also be referred to as a Tether-UE) connected to the UE1 is newly defined. In other words, the PCF may generate the URSP rule for the backend UE (the URSP rule may be referred to as the backend UE URSP rule). For example, the URSP rule may be defined as a Tether-URSP. The Tether-URSP rule may include the following content:
rule precedence: The rule precedence indicates an execution order of the Tether-URSP rule in the UE1; and
a traffic descriptor: The traffic descriptor describes traffic information of a backend UE that conforms to the Tether-URSP rule, and may further include the following content:
a device type: a device type of the backend UE, such as a drone, a smartwatch, or an XR device;
a domain descriptor: an FQDN(s) or a regular expression used as a domain matching condition;
an IP descriptor: a target IP 3-tuple (an IP address or an IPv6 network prefix, a port number, or a protocol ID of a protocol above IP);
a connection capability: This matches information provided by a backend UE application when requesting a network connection having a specific capability or a service category, where the connection capability may be: “ims”, “mms”, “internet”, or the like.
a route selection descriptor (RSD): The route selection described in the RSD is performed for the traffic of the backend UE that matches the traffic descriptor. The RSD may further include the following content:
SSC mode selection;
network slice selection: a list of one or more pieces of S-NSSAI;
DNN selection: a list of one or more DNN values; and
PDU session type selection: a PDU session type, and the like.

The route selection validity condition may include at least one of the following:
a time window: The time window defines time allowed by traffic, and when the time is not within the time window, the RSD is invalid; or
location criteria: The location criteria define a UE location where the traffic is allowed. When a current location of the UE does not match locations defined in the location criteria, the RSD is invalid.

When receiving Tether-URSP rules, the UE1 may match a service flow for traffic of a backend UE connected through a hotspot, and a matching order is precedence of the Tether-URSP rules. When the UE1 matches a specific Tether-URSP rule for the traffic of the backend UE connected through the hotspot (the matched specific Tether-URSP rule is referred to as a target backend UE URSP rule), an RSD in the specific Tether-URSP rule may be executed (the executed RSD is referred to as a target RSD). If the specific Tether-URSP rule includes a “route selection validity condition”, the target RSD is executed when (e.g., only when) the route selection validity condition is satisfied.

A method for executing the target RSD is: if a PDU session (a target PDU session) has been established for the matched Tether-URSP rule, transmitting the service flow of the backend UE on the PDU session or initiating an update procedure for the PDU session; and initiating an PDU session establishment procedure if no PDU session has been established for the matched Tether-URSP rule.

In S520, the PCF transmits the UE route selection policy rule to the terminal. For example, the UE route selection policy rule information is transmitted to the terminal device.

In some embodiments, the PCF may transmit a generated URSP rule to the terminal UE1 through an AMF, but this disclosure is not limited thereto. In some other embodiments, a URSP rule formulated by the PCF may be transmitted to the UE1 sequentially through an SMF, an AMF, and a base station. The backend UE URSP rule (that is, the Tether-URSP rule) in the URSP rule is configured for: when the backend UE initiates a new service flow, determining which Tether-URSP rule matches the service flow. If the matched Tether-URSP rule has a matched PDU session, the service flow is transmitted on the PDU session or an update procedure is initiated for the PDU session; or if the matched Tether-URSP rule does not have a matched PDU session, a procedure to establish the PDU session is initiated.

The URSP has a plurality of URSP rules, including backend UE URSP rules (that is, Tether-URSP rules). One or more applications may be installed on the backend UE. When an application on the backend UE is started, the UE1 may match traffic description information in a backend UE URSP rule according to a traffic characteristic of the application started on the backend UE, and route data of the started application according to an RSD corresponding to the traffic description information.

The backend UE URSP rule may include one or more RSDs, and each RSD may indicate a corresponding PDU session. For example, the RSD may include parameters for PDU session establishment, such as a DNN, a network slice selection policy, S-NSSAI, and a PDU session type. PDU sessions corresponding to different RSDs may provide different network access experience.

The data transmission method provided in this disclosure enhances the URSP rule when the PCF generates the URSP for this terminal, and the backend UE URSP rule is generated for the backend UE accessing the mobile network through this terminal, so that a service flow of the backend UE accessing the mobile network through the terminal may select a PDU session (in some embodiments, bind a QoS flow), thereby better supporting network quality assurance for the service flow of the backend UE accessing the mobile network through the terminal.

For other content of the embodiment of FIG. 5, refer to the foregoing embodiment.

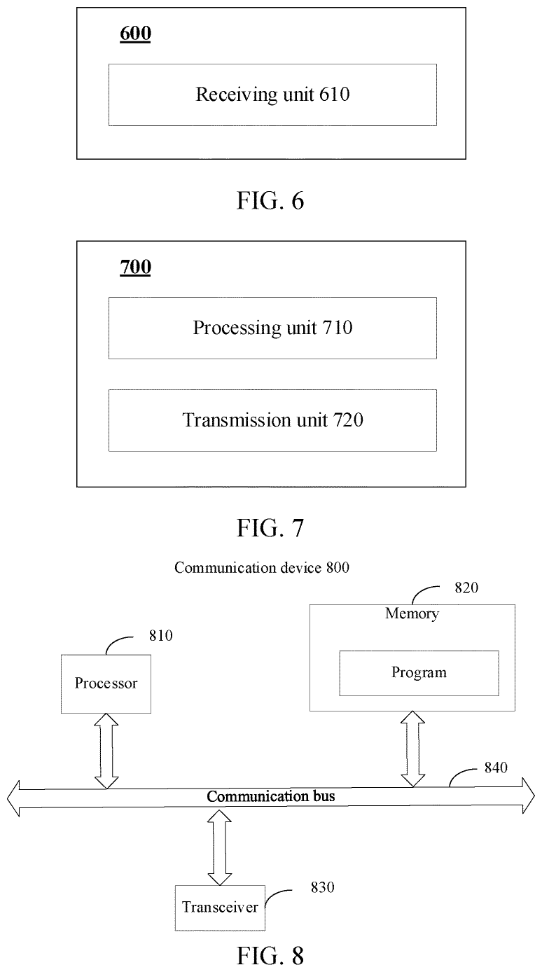

FIG. 6 shows a block diagram of a terminal according to an embodiment of the present disclosure. The terminal 600 provided in one or more embodiments of FIG. 6 may include a receiving unit 610.

The receiving unit 610 is configured to receive a UE route selection policy rule, the UE route selection policy rule including backend UE route selection policy rules, each backend UE route selection policy rule including traffic description information and a route selection descriptor, the traffic description information being configured for describing traffic information of a backend UE, the backend UE accessing a mobile network through the terminal, and the route selection descriptor being configured for performing, for traffic of the backend UE that matches the traffic description information, route selection described in the route selection descriptor.

In an embodiment, the terminal 600 further includes a processing unit, configured to: when the backend UE accesses the mobile network through the terminal, match a target backend UE route selection policy rule from the backend UE route selection policy rules for the traffic of the backend UE; and execute, when the target backend UE route selection policy rule is matched for the traffic of the backend UE, a target route selection descriptor in the target backend UE route selection policy rule.

In some embodiments of the present disclosure, the backend UE route selection policy rule further includes rule precedence. The processing unit is further configured to match the target backend UE route selection policy rule from the backend UE route selection policy rules according to an order of the rule precedence in the backend UE route selection policy rules.

In some embodiments of the present disclosure, the processing unit is further configured to: if the target backend UE route selection policy rule further includes a target route selection validity condition, execute the target route selection descriptor when the traffic of the backend UE satisfies the target route selection validity condition.

In some embodiments of the present disclosure, the processing unit is further configured to: if a target protocol data unit session matching a route selection policy rule corresponding to the traffic of the backend UE exists, transmit a service flow corresponding to the traffic of the backend UE on the target protocol data unit session, or initiate an update procedure for the target protocol data unit session; and if no target protocol data unit session matching the route selection policy rule corresponding to the traffic of the backend UE exists, initiate a procedure to establish the target protocol data unit session.

In some embodiments of the present disclosure, the terminal 600 further includes a transmission unit, configured to report target backend UE route selection policy rule reporting information matching the traffic of the backend UE, the target backend UE route selection policy rule reporting information including the target backend UE route selection policy rule, and the target backend UE route selection policy rule reporting information reported by the terminal includes at least one of a connection capability, a rule identifier, or backend device indication information.

In some embodiments of the present disclosure, the terminal 600 further includes a transmission unit, configured to report capability information of the terminal, where the capability information indicates whether the terminal supports executing the backend UE route selection policy rule for the backend UE.

For other content of the terminal provided in one or more embodiments of FIG. 6, refer to the foregoing other embodiments.

FIG. 7 shows a block diagram of a policy control function network element according to an embodiment of the present disclosure. The policy control function network element 700 provided in FIG. 7 may include a processing unit 710 and a transmission unit 720.

The processing unit 710 is configured to generate a UE route selection policy rule, the UE route selection policy rule including backend UE route selection policy rules, each backend UE route selection policy rule including traffic description information and a route selection descriptor, the traffic description information being configured for describing traffic information of a backend UE, the backend UE accessing a mobile network through a terminal, and the route selection descriptor being configured for performing, for traffic of the backend UE that matches the traffic description information, route selection described in the route selection descriptor. The transmission unit 720 is configured to transmit the UE route selection policy rule to the terminal.

In an embodiment, the UE route selection policy rule includes a traffic descriptor, the traffic descriptor including a connected backend UE descriptor, the connected backend UE descriptor serving as traffic description information of a connected backend UE. The UE route selection policy rule including the connected backend UE descriptor in the traffic descriptor is the backend UE route selection policy rule.

In an embodiment, the backend UE route selection policy rule further includes rule precedence.

In an embodiment, the backend UE route selection policy rule includes rule precedence, a traffic descriptor, and a connected backend UE traffic descriptor, the connected backend UE traffic descriptor serving as traffic description information of a connected backend UE. The UE route selection policy rule including the traffic descriptor and the connected backend UE traffic descriptor is the backend UE route selection policy rule.

In an embodiment, the backend UE route selection policy rule is a UE route selection policy rule for the backend UE, and the backend UE route selection policy rule includes a traffic descriptor, the traffic descriptor serving as traffic description information of a connected backend UE.

In an embodiment, the backend UE route selection policy rule further includes rule precedence, the rule precedence indicating an execution order of the backend UE route selection policy rule in the terminal.

In an embodiment, the traffic description information includes at least the following:
a device type, indicating a device type of the backend UE;
a domain descriptor;
an Internet protocol descriptor; or
a connection capability.

In an embodiment, the backend UE route selection policy rule further includes a route selection validity condition, the route selection validity condition indicating that the route selection descriptor is valid when the backend UE satisfies the route selection validity condition.

In an embodiment, the policy control function network element 700 further includes a receiving unit, configured to receive target backend UE route selection policy rule reporting information matching the traffic of the backend UE and reported by the terminal, the target backend UE route selection policy rule reporting information including a target backend UE route selection policy rule, and the target backend UE route selection policy rule reporting information includes at least one of the following: a connection capability; a rule identifier; or backend device indication information.

In an embodiment, the processing unit 710 is further configured to deliver a target quality of service policy for a target protocol data unit session according to the target backend UE route selection policy rule reporting information.

In an embodiment, the policy control function network element 700 further includes a receiving unit, configured to receive capability information reported by the terminal. The processing unit 710 is further configured to generate, if the capability information indicates that the terminal supports executing a backend UE route selection policy rule for the backend UE, a UE route selection policy including the backend UE route selection policy rule.

For other content of the policy control function network element provided in one or more embodiments of FIG. 7, refer to the foregoing other embodiments.

FIG. 8 shows a schematic structural diagram of a communication device 800 according to an embodiment of the present disclosure. The communication device may be a terminal such as a UE, a network device such as a base station, or a PCF network element and/or an NEF network element and/or an AF network element and/or an SMF network element and/or a UPF network element. The communication device 800 shown in FIG. 8 includes processing circuitry, such as a processor 810. The processor 810 may invoke and execute a computer program from a memory, to implement the method in the embodiments of the present disclosure.

In some embodiments, as shown in FIG. 8, the communication device 800 may further include a memory 820. The processor 810 may invoke and execute a computer program from the memory 820, to implement the method in the embodiments of the present disclosure.

The memory 820 may be a separate device independent of the processor 810, or may be integrated into the processor 810. In some examples, the memory 820 includes a non-transitory computer-readable storage medium.

In some embodiments, as shown in FIG. 8, the communication device 800 may further include a transceiver 830. The processor 810 may control the transceiver 830 to communicate with another device, and specifically, may be transmit information or data to another device, or receive information or data transmitted by another device.

The transceiver 830 may include a transmitter (which may serve as a transmission unit in the foregoing embodiments) and a receiver (which may serve as a receiving unit in the foregoing embodiments). The transceiver 830 may further include an antenna, and one or more antennas may be provided.

In some embodiments, the communication device 800 may be various network elements in the embodiments of the present disclosure, and the communication device 800 may implement corresponding processes implemented by the network elements in the methods in the embodiments of the present disclosure. For brevity, details are not described herein again.

In some embodiments, the communication device 800 may be a mobile terminal/terminal in the embodiments of the present disclosure, and the communication device 800 may implement corresponding processes implemented by the mobile terminal/terminal in the methods in the embodiments of the present disclosure. For brevity, details are not described herein again.

In some embodiments, the processor 810, the memory 820, and the transceiver 830 may implement mutual bidirectional communication through a communication bus 840.

The processor in one or more embodiments may be an integrated circuit chip having a signal processing capability. In an implementation process, the operations of the foregoing method embodiments may be completed by using a hardware integrated logic circuit or instructions in the form of software in the processor.

The processor may be a general-purpose processor, a digital signal processor (DSP), an application specific integrated circuit (ASIC), a field programmable gate array (FPGA), or another programmable logic device, discrete gate or transistor logic device, or discrete hardware component. The methods, the operations, and the logical block diagrams disclosed in the embodiments of the present disclosure may be implemented or performed. The general-purpose processor may be a microprocessor, or the processor may be any processor, or the like. The operations of the methods disclosed with reference to the embodiments of the present disclosure may be directly performed and completed by a hardware decoding processor, or may be performed and completed by using a combination of a hardware module and a software module in a decoding processor. The software module may be located in a storage medium, such as a random access memory, a flash memory, a read-only memory, a programmable read-only memory, an electrically erasable programmable memory, or a register. The storage medium is located in the memory, and the processor reads information in the memory and completes the operations of the foregoing methods with reference to the hardware of the processor.

The memory in one or more embodiments may be a volatile memory or a non-volatile memory, or may include both a volatile memory and a non-volatile memory. The non-volatile memory may be a read-only memory (ROM), a programmable ROM (PROM), an erasable PROM (EPROM), an electrically EPROM (EEPROM), or a flash memory. The volatile memory may be a random access memory (RAM), and serves as an external cache. In some examples, RAMs in many forms are available, for example, a static RAM (SRAM), a dynamic RAM (DRAM), a synchronous DRAM (SDRAM), a double data rate SDRAM (DDR SDRAM), an enhanced SDRAM (ESDRAM), a synchlinkDRAM (SLDRAM), and a direct rambus RAM (DR RAM). The memory in the system and the method described in this specification is intended to include but is not limited to these memories and any other appropriate type of memory. In some examples, the memory 820 includes a non-transitory computer-readable storage medium. The memory is a non-limiting example rather than restrictive description.

The present disclosure further provides a non-transitory computer-readable storage medium, configured to store a computer program.

In some embodiments, the non-transitory computer-readable storage medium may be disposed in the network elements in the embodiments of the present disclosure, and the computer program causes a computer to perform the corresponding procedures implemented by the network elements in the methods in the embodiments of the present disclosure. For brevity, details are not described herein again.

In some embodiments, the non-transitory computer-readable storage medium may be disposed in a mobile terminal/terminal in the present disclosure, and the computer program causes a computer to perform the corresponding procedures implemented by the mobile terminal/terminal in the methods in the embodiments of the present disclosure. For brevity, details are not described herein again.

The present disclosure further provides a computer program product, including computer program instructions.

In some embodiments, the computer program product may be stored and/or executed by the network elements in the present disclosure, and the computer program instructions cause a computer to perform the corresponding procedures implemented by the network elements in the methods in one or more embodiments of the present disclosure. For brevity, details are not described herein again.

In some embodiments, the computer program product may be stored and/or executed by a mobile terminal/a terminal in the present disclosure, and the computer program instructions cause the computer to perform the corresponding procedures implemented by the mobile terminal/the terminal in the methods in one or more embodiments of the present disclosure. For brevity, details are not described herein again.

The present disclosure further provides a computer program.

In some embodiments, the computer program may be stored and/or executed by the network elements in the embodiments of the present disclosure, and the computer program, when executed on a computer, causes the computer to perform the corresponding procedures implemented by the network elements in the methods in the embodiments of the present disclosure are made to perform. For brevity, details are not described herein again.

In some embodiments, the computer program may be stored and/or executed by a mobile terminal/a terminal in the embodiments of the present disclosure, and the computer program, when executed on a computer, causes the computer to perform the corresponding procedures implemented by the mobile terminal/the terminal in the methods in the embodiments of the present disclosure. For brevity, details are not described herein again.

A person of ordinary skill in the art may be aware that, with reference to embodiments disclosed in this specification, units and algorithm operations of each example described can be implemented by electronic hardware, or a combination of computer software and electronic hardware. Whether the functions are executed by a hardware method or a software method depends on a specific application and a design constraint condition of the technical solutions. A person skilled in the art may use different methods to implement the described functions for each specific application, but the implementation may not exceed the scope of the present disclosure.

A person skilled in the art may understand that, for convenient and concise description, for a specific working process of the foregoing system, apparatus, and unit, reference can be made to a corresponding process in the foregoing method embodiments, and details are not described herein again.

In the several embodiments provided in the present disclosure, the disclosed system, apparatus, and method may be implemented in other manners. For example, the described apparatus embodiments are merely non-limiting examples. For example, the unit division is merely logical function division and there may be another division in actual implementation. For example, a plurality of units or components may be combined or integrated into another system, or some features may be ignored or not performed.

Units described as separate parts may or may not be physically separate, and parts displayed as units may or may not be physical units, may be located in one position, or may be distributed on a plurality of network units. Some or all of the units may be selected according to a practical requirement to achieve the objectives of the solutions of the embodiments.

In addition, each functional unit in the embodiments of this present disclosure may be integrated into one processing unit, or each unit may exist alone physically, or two or more units are integrated into one unit.

When a function is implemented in a form of a software function unit and sold or used as an independent product, the function may be stored in one non-transitory computer-readable storage medium. Based on such an understanding, the technical solutions of the present disclosure, or a part of the technical solutions, may be implemented in a form of a software product. The computer software product is stored in a non-transitory computer-readable storage medium and includes several instructions for instructing a computer device (that may be a personal computer, a server, a network device, or the like) to perform all or some of the operations of the methods described in one or more embodiments of the present disclosure. In some examples, the storage medium for storing the instructions includes: any medium that can have program code stored therein, such as a USB flash drive, a removable hard disk, a read-only memory, a random access memory, a magnetic disk, or an optical disc.

One or more modules, submodules, and/or units of the apparatus can be implemented by processing circuitry, software, or a combination thereof, for example. The term module (and other similar terms such as unit, submodule, etc.) in this disclosure may refer to a software module, a hardware module, or a combination thereof. A software module (for example, computer program) may be developed using a computer programming language and stored in memory or non-transitory computer-readable medium. The software module stored in the memory or medium is executable by a processor to thereby cause the processor to perform the operations of the module. A hardware module may be implemented using processing circuitry, including at least one processor and/or memory. Each hardware module can be implemented using one or more processors (or processors and memory). Likewise, a processor (or processors and memory) can be used to implement one or more hardware modules. Moreover, each module can be part of an overall module that includes the functionalities of the module. Modules can be combined, integrated, separated, and/or duplicated to support various applications. Also, a function being performed at a particular module can be performed at one or more other modules and/or by one or more other devices instead of or in addition to the function performed at the particular module. Further, modules can be implemented across multiple devices and/or other components local or remote to one another. Additionally, modules can be moved from one device and added to another device, and/or can be included in both devices.

The foregoing descriptions are merely implementation examples of the present disclosure, and are not intended to limit the scope of the present disclosure. Any variation or replacement within the technical scope disclosed in the present disclosure shall fall within the scope of the present disclosure.

What is claimed is:

1. A data transmission method, the method comprising:
receiving, by processing circuitry of a terminal device, user equipment (UE) route selection policy rule information that includes a traffic descriptor and a backend UE descriptor included in the traffic descriptor or the UE route selection policy rule information independent of the traffic descriptor, the backend UE descriptor including traffic description information and a route selection information, the traffic description information indicating one or more of a backend device type, a domain descriptor, an Internet protocol descriptor, or connection capability information;
determining whether the UE route selection policy rule information matches a backend UE connected to the terminal device; and
when the UE route selection policy rule information matches the backend UE, configuring, by the processing circuitry, communication between the backend UE and a mobile network through the terminal device based on the backend UE descriptor.

2. The method according to claim 1, wherein the UE route selection policy rule information further includes rule precedence information indicating execution precedence of the UE route selection policy rule information in the terminal device.

3. The method according to claim 1, wherein the traffic description information includes backend device type information indicating that the backend UE descriptor is applicable to the backend device type that includes an unmanned aerial vehicle, a wearable computing device, or a handheld computing device.

4. The method according to claim 1, wherein
the backend UE descriptor is included in the traffic descriptor, and
one or more parameters in the traffic descriptor that contradict the backend UE descriptor are invalid for configuring the communication between the backend UE and the mobile network through the terminal device.

5. The method according to claim 1, wherein
the backend UE descriptor is included in the UE route selection policy rule information independent of the traffic descriptor, and
the traffic descriptor is empty or invalid for configuring the communication between the backend UE and the mobile network through the terminal device.

6. The method according to claim 1, wherein
the backend UE descriptor includes route selection validity condition information indicating that the route selection information is valid when the backend UE satisfies the route selection validity condition information.

7. The method according to claim 1, further comprising:
reporting target backend UE route selection policy rule reporting information matching traffic of the backend UE, the target backend UE route selection policy rule reporting information indicating matched target backend UE route selection policy rule information, and the target backend UE route selection policy rule reporting information reported by the terminal device including one or more of:
a connection capability;
a rule identifier; or
backend device indication information.

8. The method according to claim 1, further comprising:
reporting capability information of the terminal device, the capability information indicating whether the terminal device supports a function of configuring the communication for the backend UE based on the UE route selection policy rule information that matches the backend UE.

9. A data transmission method, the method comprising:
receiving, by processing circuitry of a network processing device, capability information of a terminal device, the capability information indicating that the terminal device supports a function of configuring communication between a backend UE and a mobile network through the terminal device based on a backend UE descriptor;
generating, by the processing circuitry, user equipment (UE) route selection policy rule information that includes a traffic descriptor and the backend UE descriptor included in the traffic descriptor or the UE route selection policy rule information independent of the traffic descriptor, the backend UE descriptor including traffic description information and a route selection information, the traffic description information indicating one or more of a backend device type, a domain descriptor, an Internet protocol descriptor, or connection capability information; and
transmitting the UE route selection policy rule information to the terminal device.

10. The method according to claim 9, wherein the UE route selection policy rule information further includes rule precedence information indicating execution precedence of the UE route selection policy rule information in the terminal device.

11. The method according to claim 9, wherein the traffic description information includes backend device type information indicating that the backend UE descriptor is applicable to the backend device type that includes an unmanned aerial vehicle, a wearable computing device, or a handheld computing device.

12. The method according to claim 9, wherein
the backend UE descriptor is included in the traffic descriptor, and
one or more parameters in the traffic descriptor that contradict the backend UE descriptor are invalid for configuring the communication between the backend UE and the mobile network through the terminal device.

13. The method according to claim 9, wherein
the backend UE descriptor is included in the UE route selection policy rule information independent of the traffic descriptor, and
the traffic descriptor is empty or invalid for configuring the communication between the backend UE and the mobile network through the terminal device.

14. The method according to claim 9, wherein
the backend UE descriptor includes route selection validity condition information indicating that the route selection information is valid when the backend UE satisfies the route selection validity condition information.

15. The method according to claim 9, further comprising:
receiving, from the terminal device, target backend UE route selection policy rule reporting information matching traffic of the backend UE, the target backend UE route selection policy rule reporting information indicating matched target backend UE route selection policy rule information, and the target backend UE route selection policy rule reporting information reported by the terminal device including one or more of:
a connection capability;
a rule identifier; or
backend device indication information.

16. The method according to claim 15, further comprising:
delivering target quality of service policy information for a target protocol data unit session according to the target backend UE route selection policy rule reporting information.

17. A terminal device, comprising:
processing circuitry configured to:
receive user equipment (UE) route selection policy rule information that includes a traffic descriptor and a backend UE descriptor included in the traffic descriptor or the UE route selection policy rule information independent of the traffic descriptor, the backend UE descriptor including traffic description information and a route selection information, the traffic description information indicating one or more of a backend device type, a domain descriptor, an Internet protocol descriptor, or connection capability information;
determine whether the UE route selection policy rule information matches a backend UE connected to the terminal device; and
when the UE route selection policy rule information matches the backend UE, configure communication between the backend UE and a mobile network through the terminal device based on the backend UE descriptor.

18. The terminal device according to claim 17, wherein the UE route selection policy rule information further includes rule precedence information indicating execution precedence of the UE route selection policy rule information in the terminal device.

19. The terminal device according to claim 17, wherein the traffic description information includes backend device type information indicating that the backend UE descriptor is applicable to the backend device type that includes an unmanned aerial vehicle, a wearable computing device, or a handheld computing device.

20. The terminal device according to claim 17, wherein
when the backend UE descriptor is included in the traffic descriptor, one or more parameters in the traffic descriptor that contradict the backend UE descriptor are invalid for configuring the communication between the backend UE and the mobile network through the terminal device, and
when the backend UE descriptor is included in the UE route selection policy rule information independent of the traffic descriptor, the traffic descriptor is empty or invalid for configuring the communication between the backend UE and the mobile network through the terminal device.
